(19) United States
(12) Patent Application Publication
(10) Pub. No.: US 2026/0302631 A1
(43) Pub. Date: Oct. 1, 2026

(54) RADIATING ELEMENT, ANTENNA ARRAY, ANTENNA, AND REMOTE ELECTRICAL TILT ANTENNA

(71) Applicant: Outdoor Wireless Networks LLC, Richardson, TX (US)

(72) Inventors: Cheng Xue, Suzhou (CN); Changfu Chen, Suzhou (CN); Bin Sun, Suzhou (CN); Jian Zhang, Suzhou (CN); Pengfei Guo, Suzhou (CN)

(21) Appl. No.: 19/573,083

(22) Filed: Mar. 20, 2026

(30) Foreign Application Priority Data
Mar. 31, 2025 (CN) 202510396637.5

(51) Int. Cl. H01Q 9/16

(52) U.S. Cl. CPC H01Q 9/16

(57) ABSTRACT

A radiating element comprises a feeder pillar and a radiator positioned at the front end of the feeder pillar. The radiator comprises a first part located on a first side of the feeder pillar and a second part located on a second side of the feeder pillar opposite the first side, where the size of the first part of the radiator is larger than the size of the second part.

### CROSS-REFERENCE TO RELATED APPLICATION

The present application claims priority to Chinese Patent Application No. 202510396637.5, filed Mar. 31, 2025, the entire content of which is incorporated herein by reference as if set forth fully herein.

### FIELD

The present disclosure generally relates to the field of radio communication and, more specifically, to a radiating element, an antenna array, an antenna, and a remote electrical tilt antenna

### BACKGROUND

Cellular communication systems are well known in this field. In a cellular communications system, a geographic region is divided into a series of areas, called cells, which are served by corresponding base stations. Each base station may comprise one or more antennas that are configured to provide two-way radio frequency (“RF”) communications with fixed and mobile subscribers located in the cells served by the base station.

Many cells are divided into “sectors”. In perhaps the most common configuration, the hexagonal cell is divided into three 120° sectors, and each sector is served by one or more antennas. Antennas are often installed on towers, where the radiation pattern generated by the antenna (also referred to herein as “pattern”) extend outwardly.

The antenna comprises a plurality of antenna arrays, with each of the antenna array including multiple radiating elements; when the antenna is installed for use, the radiating elements are arranged in one or more vertical columns. That is, the antennas are often realized as linear or planar phased arrays of radiating elements.

### SUMMARY

A brief overview of the present disclosure is given below in order to provide a basic understanding of some aspects of the present disclosure. However, it should be understood that this overview is not an exhaustive overview of the present disclosure. It is not intended to be used to determine a critical or important part of the present disclosure, nor is it intended to be used to define the scope of the present disclosure. The purpose is merely to provide certain concepts of the present disclosure in simplified form as a preamble to the more detailed description provided later.

According to a first aspect of the present disclosure, a radiating element is provided, including: a feeder pillar; and a radiator positioned at the front end of the feeder pillar, the radiator comprising a first part located on a first side of the feeder pillar and a second part located on a second side of the feeder pillar opposite the first side, wherein the size of the first part of the radiator is larger than the size of the second part.

In some embodiments, the first part and the second part of the radiator have the same shape.

In some embodiments, the sizes of the first part and the second part of the radiator are determined based on the intensity of the radiated energy in the direction in which grating lobes are formed in the antenna array where the radiating element is arranged.

In some embodiments, the radiating element further includes: a director positioned in front of the radiator, the director comprising a first part located on the first side of the feeder pillar and a second part located on the second side of the feeder pillar, wherein the size of the first part of the director is larger than the size of the second part.

In some embodiments, the first part and the second part of the director have the same shape.

In some embodiments, the sizes of the first part and the second part of the director are determined based on the intensity of the radiated energy in the direction in which grating lobes are formed in the antenna array where the radiating element is arranged.

In some embodiments, the radiating element further includes: a metasurface positioned in front of the radiator, the metasurface comprising a first part located on the first side of the feeder pillar and a second part located on the second side of the feeder pillar, wherein the metasurface is configured to perform at least one of the following: the metasurface is offset by a distance in the direction of the first side of the feeder pillar relative to the feeder pillar; or the metasurface is rotated by an angle around a second direction transverse to a first direction, where the first direction points from the first side of the feeder pillar to the second side of the feeder pillar; or the first part of the metasurface comprises a plurality of first metasurface units arranged periodically, and the second part of the metasurface comprises a plurality of second metasurface units arranged periodically, wherein the plurality of first metasurface units and the plurality of second metasurface units are configured such that the amount of energy from the radiator reflected by the plurality of first metasurface units is greater than the amount of energy from the radiator reflected by the plurality of second metasurface units; or the metasurface comprises a plurality of periodically arranged metasurface units and a plurality of lumped elements disposed between the metasurface units, and the inductance value and/or capacitance value of each lumped element in the plurality of lumped elements are configured such that the amount of energy from the radiator reflected by the first part of the metasurface is greater than the amount of energy from the radiator reflected by the second part of the metasurface.

According to a second aspect of the present disclosure, a radiating element is provided, including: a feeder pillar; a radiator positioned at the front end of the feeder pillar; and a metasurface located in front of the radiator, wherein the metasurface includes a first part on the first side of the feeder pillar and a second part on the second side of the feeder pillar, which is opposite to the first side, and the metasurface is configured such that the amount of energy from the radiator reflected by the first part of the metasurface is greater than the amount of energy from the radiator reflected by the second part of the metasurface.

In some embodiments, the metasurface is offset by a distance relative to the feeder pillar toward a direction of the first side of the feeder pillar.

In some embodiments, the offset distance is determined based on the intensity of the radiated energy in the direction in which grating lobes are formed in the antenna array where the radiating element is arranged.

In some embodiments, the metasurface is rotated by an angle around a second direction transverse to the first direction, where the first direction points from the first side of the feeder pillar to the second side of the feeder pillar.

In some embodiments, the rotation angle is determined based on the intensity of the radiated energy in the direction in which grating lobes are formed in the antenna array where the radiating element is arranged.

In some embodiments, the offset distance and/or the rotation angle of the metasurface are adjustable.

In some embodiments, the first part of the metasurface includes multiple first metasurface units arranged periodically, and the second part of the metasurface includes multiple second metasurface units arranged periodically, where the multiple first metasurface units are different from the multiple second metasurface units.

In some embodiments, the equivalent capacitance of the multiple first metasurface units is greater than the equivalent capacitance of the multiple second metasurface units, and/or the equivalent inductance of the multiple first metasurface units is greater than the equivalent inductance of the multiple second metasurface units.

In some embodiments, the periodic arrangement of the multiple first metasurface units and the periodic arrangement of the multiple second metasurface units are determined based on the intensity of the radiated energy in the direction in which grating lobes are formed in the antenna array where the radiating element is arranged.

In some embodiments, the metasurface includes a plurality of metasurface units arranged periodically and a plurality of lumped elements arranged between the metasurface units, where the inductance value and/or capacitance value of each lumped element in the plurality of lumped elements is adjustable.

In some embodiments, the capacitance value of the lumped elements in the first part of the metasurface is greater than the capacitance value of the lumped elements in the second part of the metasurface, and/or the inductance value of the lumped elements in the first part of the metasurface is greater than the inductance value of the lumped elements in the second part of the metasurface.

In some embodiments, the inductance value and/or capacitance value of each lumped element in the multiple lumped elements are determined based on the intensity of the radiated energy in the direction in which grating lobes are formed in the antenna array where the radiating element is arranged.

In some embodiments, the radiator comprising a first part located on the first side of the feeder pillar and a second part located on the second side of the feeder pillar, wherein the size of the first part of the radiator is larger than the size of the second part.

In some embodiments, the radiating element further includes a director positioned in front of the radiator and behind the metasurface, wherein: the radiator comprising a first part located on the first side of the feeder pillar and a second part located on the second side of the feeder pillar, wherein the size of the first part of the radiator is larger than the size of the second part; and/or the director comprising a first part located on the first side of the feeder pillar and a second part located on the second side of the feeder pillar, wherein the size of the first part of the director is larger than the size of the second part.

According to a third aspect of the present disclosure, a radiating element is provided, including: a feeder pillar; a radiator positioned at the front end of the feeder pillar; and a director positioned in front of the radiator, the director comprising a first part located on a first side of the feeder pillar and a second part located on a second side of the feeder pillar opposite the first side, wherein the size of the first part of the director is larger than the size of the second part.

In some embodiments, the first part and the second part of the director have the same shape.

In some embodiments, the sizes of the first part and the second part of the director are determined based on the intensity of the radiated energy in the direction in which grating lobes are formed in the antenna array where the radiating element is arranged.

In some embodiments, the radiator comprises a first part located on the first side of the feeder pillar and a second part located on the second side of the feeder pillar, wherein the size of the first part of the radiator is larger than the size of the second part.

In some embodiments, the radiating element further includes: a metasurface positioned in front of the director, the metasurface comprising a first part located on the first side of the feeder pillar and a second part located on the second side of the feeder pillar, wherein the metasurface is configured to perform at least one of the following: the metasurface is offset by a distance in the direction of the first side of the feeder pillar relative to the feeder pillar; or the metasurface is rotated by an angle around a second direction transverse to a first direction, where the first direction points from the first side of the feeder pillar to the second side of the feeder pillar; or the first part of the metasurface comprises a plurality of first metasurface units arranged periodically, and the second part of the metasurface comprises a plurality of second metasurface units arranged periodically, wherein the plurality of first metasurface units and the plurality of second metasurface units are configured such that the amount of energy from the radiator reflected by the plurality of first metasurface units is greater than the amount of energy from the radiator reflected by the plurality of second metasurface units; or the metasurface comprises a plurality of periodically arranged metasurface units and a plurality of lumped elements disposed between the metasurface units, and the inductance value and/or capacitance value of each lumped element in the plurality of lumped elements are configured such that the amount of energy from the radiator reflected by the first part of the metasurface is greater than the amount of energy from the radiator reflected by the second part of the metasurface.

According to a fourth aspect of the present disclosure, an antenna array is provided, including a plurality of radiating elements according to any one of embodiments of the first or second or third aspect of the present disclosure.

In some embodiments, the spacing between the radiating elements is between 0.5 times and 1.5 times the wavelength corresponding to the center frequency of the frequency range in which the radiating elements are configured to operate.

According to a fifth aspect of the present disclosure, an antenna is provided, including a radiating element according to any one of embodiments of the first or second or third aspect of the present disclosure, or an antenna array according to any one of embodiments of the fourth aspect of the present disclosure.

In some embodiments, the antenna is configured to generate a radiation pattern that is downtilted, with the first side being the lower side and the second side being the upper side; or the antenna is configured to generate a radiation pattern that is uptilted, with the first side being the upper side and the second side being the lower side.

According to a sixth aspect of the present disclosure, a RET antenna is provided, including: a reflector; a radiating element installed in front of the reflector, wherein the radiating element is a radiating element according to any one of embodiments of the second aspect of the present disclosure and is part of an array of radiating elements; a first driving mechanism configured to adjust an electronic inclination angle of radiation patterns generated by the array of radiating elements; and a second driving mechanism configured to, in response to the adjustment of the electronic inclination angle, offset the metasurface of the radiating element in a first direction parallel to the reflector, and/or rotate the metasurface of the radiating element around a second direction perpendicular to the first direction and parallel to the reflector.

According to a seventh aspect of the present disclosure, a RET antenna is provided, including: a reflector; a radiating element installed in front of the reflector, wherein the radiating element is a radiating element according to any one of embodiments of the second aspect of the present disclosure in which lumped elements are provided; a driving mechanism configured to adjust an electronic inclination angle of an antenna array that includes the radiating element; and a control signal generator configured to, in response to an adjustment of the electronic inclination angle, generate control signals to adjust the inductance value and/or capacitance value of the lumped elements in the metasurface of the radiating element.

### BRIEF DESCRIPTION OF THE DRAWING

The foregoing and other features and advantages of the present disclosure will become clear from the following descriptions of the examples of the present disclosure shown in conjunction with the attached drawings. The attached drawings are incorporated herein and form a part of the Specification to further explain the principles of the present disclosure and enable those skilled in the art to make and use the present disclosure. In which:

FIG. 1 shows the elevation plane pattern of a conventional array element and the desired elevation plane pattern.

FIG. 2 is a schematic perspective view of a radiating element including an asymmetric radiator according to some examples of the present disclosure.

FIG. 3 is a schematic front view of the radiating element shown in FIG. 2.

FIG. 4 is a schematic perspective view of a radiating element including an asymmetric radiator and an asymmetric director according to some examples of the present disclosure.

FIG. 5 is a schematic front view of the director of the radiating element shown in FIG. 4.

FIG. 6 is a schematic front view of the radiating element shown in FIG. 4.

FIG. 7 is a schematic side view and front view of a radiating element with a metasurface according to some examples of the present disclosure.

FIG. 8 is a schematic perspective view of the radiating element shown in FIG. 7.

FIG. 9 is a schematic front view of the metasurface of the radiating element shown in FIGS. 7-8.

FIG. 10 is a schematic side view of a radiating element with an offset metasurface according to some examples of the present disclosure.

FIG. 11 is a schematic side view of a radiating element with a rotated metasurface according to some examples of the present disclosure.

FIG. 12 is a schematic perspective view of a radiating element with an asymmetric metasurface according to some examples of the present disclosure.

FIG. 13 is a schematic front view of an asymmetric metasurface according to some examples of the present disclosure.

FIG. 14 is a schematic front view of a metasurface with lumped elements according to some examples of the present disclosure.

FIG. 15 is a schematic front view of an antenna according to some examples of the present disclosure.

FIG. 16 is an elevation plane pattern of the antenna shown in FIG. 15, along with an elevation plane pattern of an antenna that includes conventional radiating elements.

FIG. 17 is a schematic front view of a remote electrical tilt antenna, consistent with some examples of the present disclosure.

FIG. 18 schematically shows various exemplary metasurface models.

Note that in the embodiments described below, the same reference signs are sometimes jointly used between different attached drawings to denote the same parts or parts with the same functions, and repeated descriptions thereof are omitted. In this Specification, similar labels and letters are used to indicate similar items. Therefore, once an item is defined in one attached drawing, it does not need to be further discussed in subsequent attached drawings.

For ease of understanding, the position, dimension, and range of each structure shown in the attached drawings and the like may not indicate the actual position, dimension, and range. Therefore, the disclosed invention is not limited to the positions, dimensions, and ranges disclosed in the attached drawings and the like. In addition, the attached drawings are not necessarily drawn to scale, and some features may be enlarged to show details of specific components.

### DETAILED DESCRIPTION

Various exemplary examples of the present disclosure will now be described in detail by referencing the attached drawings. It should be noted that, unless otherwise specifically stated, the relative arrangement, numerical expressions and numerical values of components and steps set forth in these examples do not limit the scope of the present disclosure.

The following description of at least one exemplary example is actually only illustrative, and in no way serves as any limitation to the present disclosure and its application or use. Those skilled in the art will understand that they only illustrate exemplary ways of implementing the present disclosure, rather than exhaustive ways.

The technologies, methods, and equipment known to those of ordinary skill in the art may not be discussed in detail, but where appropriate, the technologies, methods, and equipment should be regarded as part of the specification.

In all examples shown and discussed herein, any specific value should be construed as merely exemplary value and not as limiting value. Therefore, other examples of the exemplary example may have different values.

In this context, for ease of description, the wavelength corresponding to the center frequency of the frequency range in which the radiating element is configured to operate (referred to as the operating frequency range) can be referred to as λ₀.

In an antenna array, a larger spacing between the radiating elements (for example, this spacing can exceed 0.5λ₀) can offer advantages, including but not limited to higher radiation efficiency, better isolation performance, and lower manufacturing costs, etc. However, a larger spacing between the radiating elements can lead to stronger grating lobes, which means stronger interference in non-target directions. Therefore, a new antenna array is needed that can apply larger radiating element spacing without causing strong grating lobes.

The pattern of an antenna array can be represented by the following equation:

E(θ,φ)=f(θ,φ)·F(θ,φ)

where E(θ, φ) is the antenna array pattern, θ is the elevation (EL) angle, and φ is the azimuth (AZ) angle. (θ, φ) denotes the intensity of the radiated energy of the antenna array in a given direction E (θ, φ) (also referred to as radiation intensity in this context). f(θ, φ) is an array element pattern representing the intensity of radiation in a given direction (θ, φ) for each of the radiating elements in the antenna array. F(θ, φ) is an array factor that is a function of the radiation intensity and phase of the various radiating elements in the antenna array for the effect of the orientation diagram on the antenna array overall, and is typically dependent on the spacing and phase difference between the various radiating elements in the antenna array, etc.

Typically, when the spacing between the radiating elements in an antenna array is known, the position θ_{opt.} of the grating lobes will be known in the antenna array pattern E(θ, φ). The goal is to suppress the radiation intensity of the antenna array pattern E(θ, φ) at the position θ_{opt.} According to the above formula, in order to suppress the grating lobes generated by the antenna array, on one hand, it can be achieved by modifying the array factor F(θ, φ) and on the other hand, it can be achieved by modifying the array element pattern f(θ, φ).

Adjusting the array factor F(θ, φ) can be achieved by changing the spacing between the individual radiating elements in the antenna array, the power of the sub-components of the RF signal supplied to the respective radiating elements in the antenna array (amplitude control), the phase of the sub-components of the RF signal supplied to the respective radiating elements in the antenna array (phase control), and so on. Reducing the spacing, which in base station antenna applications is typically a vertical spacing (e.g., to less than 0.5λ₀), may suppress grating lobes, but it also loses the advantages that come with larger spacings mentioned earlier. Furthermore, if the spacing becomes too small, issues such as multipath interference or beam broadening may arise. For example, amplitude control can adjust the radiation power of individual radiating elements, making the contribution of certain radiating elements stronger while weakening the contribution of other radiating elements, thereby controlling the beam shape and side lobes. However, this requires high-performance amplitude control devices, which increases the complexity and cost of the hardware. As another example, phase control can offset the phase center of each radiating elements in the antenna array by different amounts, thereby enhancing or suppressing the radiation intensity in specific directions. However, this requires high-performance phase control devices (such as phase shifters), which increases the complexity and cost of the hardware. In addition, the array factor is often designed for a specific inclination or “tilt” angle that is applied to the generated radiation pattern. When the inclination angle changes (e.g., by adjusting a remote electronic tilt unit), the grating lobe suppression effect of the array factor deteriorates or even disappears, and at this point, the array factor needs to be readjusted.

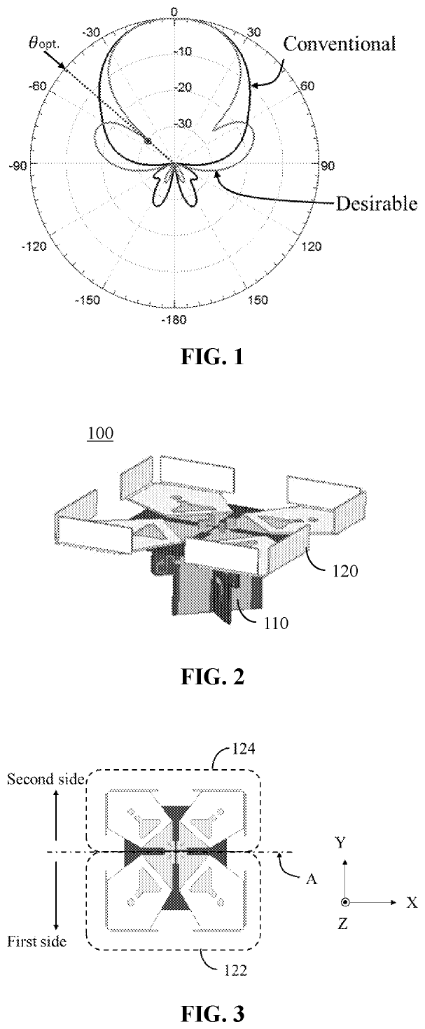

Unlike adjusting the array factor F(θ, φ), adjusting the array element's array element pattern f(θ, φ) only requires optimizing the radiation characteristics of a single radiating element, without involving interactions between multiple radiating elements. The present disclosure aims to adjust the array element's array element pattern (θ, φ) by modifying the configuration of the radiating elements to modify their radiation characteristics, thereby suppressing the grating lobes in the antenna array pattern E(θ, φ). Referring to FIG. 1, the elevation plane pattern of a conventional array element is shown by the black curve, which has a large directional coefficient at θ_{opt.} (The directional coefficient is a parameter that measures the ratio of the radiation intensity in a specific direction to a reference direction (typically the direction of maximum radiation intensity or the average radiation intensity in all directions)). The expected elevation plane pattern is shown in the gray line of FIG. 1, where the directional coefficient at θ_{opt.} is reduced. Specifically, in order to suppress the directional coefficient of array element's array element pattern f(θ, φ) at the θₒₚₜ . . . , the present disclosure modifies the configuration of the radiating element to tilt its elevation plane pattern away from the θₒₚₜ, and/or have a narrower elevation beamwidth, ultimately leading to the suppression or even elimination of grating lobes in the antenna array. By adjusting the configuration of the radiating elements, the array element's array element pattern f(θ, φ) can be modified without the need for high-performance amplitude or phase control devices, which helps simplify the hardware and reduce costs. Moreover, the antenna array formed by radiating elements with modified configurations can be applied to a wider range of inclination angles, with reduced angular sensitivity.

The following will provide a detailed description of the radiating elements according to various examples of the present disclosure, as well as the antenna arrays and antennas that include such radiating elements, with reference to the accompanying figures. It should be understood that the actual radiating elements, antenna arrays, and antennas may further comprise other components, but to avoid obscuring the key elements of the present disclosure, they will not be discussed herein, and these other components will also not be shown in the attached drawings.

For ease of explanation, in the various figures, the Y-direction is the vertical direction (also referred to as the “up-down” direction herein). This vertical direction can be defined as a direction that is perpendicular to the horizontal plane defined by the horizon, and it is assumed that the antenna extends along the Y-direction (i.e., it is installed vertically). The Z-direction is the depth direction of the antenna (also referred to as the “front-back” direction herein), and the X-direction is the width direction of the antenna (also referred to as the “left-right”direction herein). Therefore, both the Z and X directions are perpendicular to the Y-direction. It should be understood that since antennas are typically vertically installed, the description herein that one element is positioned in front of another element is performed in the case that the antenna is viewed from the front.

It should be understood that in the figures, the radiating elements may be shown with their radiators positioned above their feeder pillars. During use, the antenna is rotated 90°, so that the radiators of the radiating elements are positioned in front of the feeder pillars. The following description will describe the relative positioning of the components of the antenna as if the antenna were mounted for use even though the antenna and its radiating elements are rotated 90° relative to the orientation in the figures.

FIG. 2 is a schematic perspective view of a radiating element 100 according to some examples of the present disclosure. FIG. 3 is a schematic front view of the radiating element 100.

As shown in FIG. 1, the radiating element 100 includes a feeder pillar 110 (also referred to as a feed stalk) and a radiator 120 positioned at the front end of the feeder pillar 110. The feeder pillar 110 may be mechanically and electrically connected to the radiator 120 at a front end portion of the feeder pillar 110 (see upper end portion in FIG. 2), so as to feed an RF signal to the radiator 120. For example, when the radiating element 100 is installed in the antenna, the feeder pillar 110 can extend a certain distance forward from a reflector of the antenna, so that the radiator 120 is located at the front end of the feeder pillar 110 and is approximately 0.15λ₀ to 0.35λ₀ away from the reflector, such as being 0.25λ₀ away. It should be understood that the distance between the radiator 120 and the reflector can be set according to actual requirements, and no specific limitations are imposed on this herein.

As shown in FIG. 3, the radiator 120 includes a first part 122 and a second part 124. With the plane A, which is centered on the feeder pillar 110 and parallel to the XZ plane, as the reference, the first part 122 of the radiator 120 is located on the first side of the feeder pillar 110, and the second part 124 of the radiator 120 is located on the second side of the feeder pillar 110, which is opposite to the first side. The size of the first part 122 of the radiator 120 is larger than the size of the second part 124 of the radiator. That is, the radiator 120 is asymmetric with respect to the plane A, which is centered on the feeder pillar 110. It should be understood that, considering the case where the radiating element 100 is installed in an antenna in use, the plane A is parallel to the azimuth (AZ) plane. In this way, the elevation (EL) beam of the radiating element 100 can be tilted toward the first side of the feeder pillar 110 (i.e., the negative Y direction), thereby reducing the directional coefficient at the direction θ_{opt.}, where the grating lobes are formed, that is, suppresses the radiation intensity of the grating lobe in the elevation plane pattern at the direction θ_{opt.}

In some examples, in the direction parallel to the plane A, the sizes of the first part 122 and the second part 124 of the radiator 120 can be the same, and in the direction perpendicular to the plane A, the size of the first part 122 of the radiator 120 is larger than the size of the second part 124. In other words, in the EL direction, or say in the Y direction, the first part 122 of the radiator 120 is elongated relative to the second part 124.

In some examples, the first part 122 and the second part 124 of the radiator 120 may have the same shape. This helps promote the symmetry of the radiation pattern and the consistency of polarization. In other words, the first part 122 and the second part 124 of the radiator 120 can be the same in all aspects except for their size, and the present disclosure does not impose specific limitations on these other aspects of the radiator 120. The first part 122 and the second part 124 of the radiator 120 can also have different shapes. It should be understood that the radiator 120 can have any asymmetric design with respect to the plane A, which is centered on the feeder pillar 110, as long as the size of the first part 122 of the radiator 120 is greater than that of the second part 124.

In general, the overall size of the radiator 120 can be determined based on the wavelength λ₀. For example, when the overall size of the radiator 120 is set to 0.5λ₀, typically, the sizes of the first part 122 and the second part 124 of the radiator 120 can each be 0.25λ₀. However, in the examples of the present disclosure, the size of the first part 122 of the radiator 120 can be greater than 0.25λ₀, while the size of the second part 124 can be smaller than 0.25λ₀. In other words, under normal circumstances, the first part 122 and the second part 124 of the radiator 120 can be the same as each other, while in the examples of the present disclosure, the first part 122 of the radiator 120 can be enlarged, and the second part 124 can be reduced.

In some examples, the radiator 120 may be a dipole radiator. The ratio R₁ of the length of the first part of the dipole radiator (i.e., the first dipole arm) to the total length of the dipole radiator can be greater than 50%, and the ratio of the length of the second part of the dipole radiator (i.e., the second dipole arm) to the total length of the dipole radiator can be 1−R₁. FIG. 3 illustrates an example of a dual-polarized dipole radiator, where each dipole of the dual-polarized dipole radiator has an enlarged first dipole arm and a reduced second dipole arm. However, it should be understood that this is merely exemplary and not limiting, as a single-polarized dipole radiator is also equally applicable in this context.

In some other examples, the radiator 120 may be a patch radiator. Similarly, the ratio R₂ of the area of the first part of the patch radiator to the total area of the patch radiator can be greater than 50%, and the ratio of the area of the second part of the patch radiator to the total area of the patch radiator can be 1−R₂. In fact, regardless of the type of radiator 120, the asymmetric design taught here can be applied.

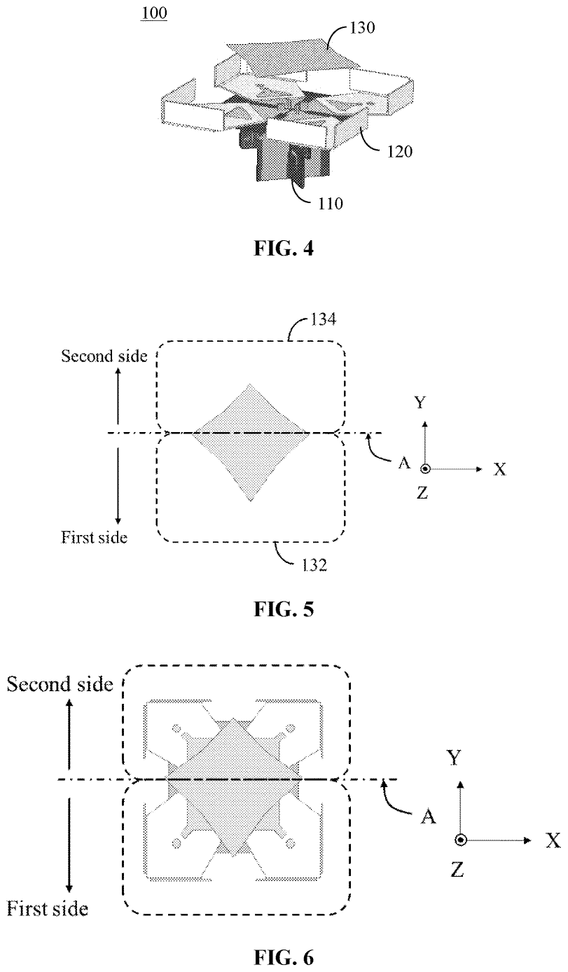

In comparison to FIG. 2, in the example shown in FIG. 4, the radiating element 100 may also include a director 130. The director 130 is positioned forward of the radiator 120. The director 130 can enhance the directivity and gain of the radiator 120. The director 130 can be spaced a certain distance from the radiator 120, for example, 0.15λ₀. It should be understood that the distance between the radiator 120 and the director 130 can be set according to actual requirements, and no specific limitations are imposed on this herein.

FIG. 5 shows a front view of the director 130 in FIG. 4. The director 130 includes a first part 132 and a second part 134. With the plane A, which is centered on the feeder pillar 110, as the reference, the first part 132 of the director 130 is located on the first side of the feeder pillar 110, and the second part 134 of the director 130 is located on the second side of the feeder pillar 110. In other words, the first part 132 of the director 130 can be located in front of the first part 122 of the radiator 120, and the second part 134 of the director 130 can be located in front of the second part 124 of the radiator 120.

Similarly, the size of the first part 132 of the director 130 can be larger than the size of the second part 134 of the director 130. That is, the director 130 is asymmetric with respect to the plane A, which is centered on the feeder pillar 110. In this way, the radiation intensity in the elevation plane pattern of the radiating element 100 at the direction θ_{opt.}, where the grating lobes are formed, can be further reduced, thereby suppressing the grating lobes of the antenna array.

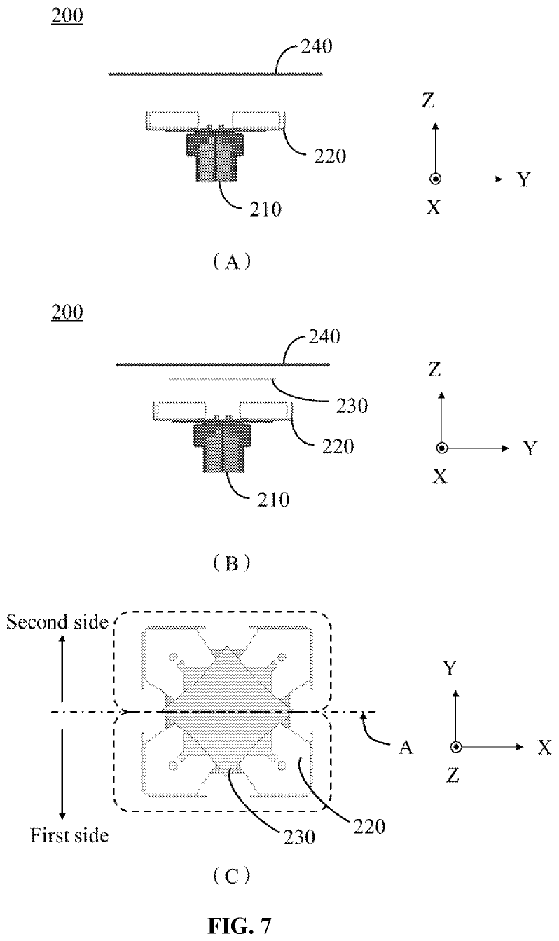

In some examples, the director 130 is sheet-like and can extend continuously in front of the radiator 120. For example, the plane in which the director 130 is located can be parallel to the plane in which the radiator 120 is located. Typically, when observing the radiating element 100 from the front, as shown in FIG. 6, the director 130 overlaps with the radiator 120 and does not extend beyond the area occupied by the radiator 120. For example, the ratio R₃ of the area of the first part 132 of the director 130 to the total area of the director 130 can be greater than 50%, and the ratio of the area of the second part 134 of the director 130 to the total area of the director 130 can be 1−R₃.

In some examples, in the direction parallel to the plane A, the sizes of the first part 132 and the second part 134 of the director 130 can be the same, and in the direction perpendicular to the plane A, the size of the first part 132 of the director 130 can be larger than the size of the second part 134. In other words, in the EL direction, or say in the Y direction, the first part 132 of the director 130 is elongated relative to the second part 134.

In some examples, the first part 132 and the second part 134 of the director 130 can have the same shape. In other words, the first part 132 and the second part 134 of the director 130 can be the same in all aspects except for their size, and the present disclosure does not impose specific limitations on these other aspects of the director 130. The first part 132 and the second part 134 of the director 130 can also have different shapes. It should be understood that the director 130 can have any asymmetric design with respect to the plane A, which is centered on the feeder pillar 110, as long as the size of the first part 132 of the director 130 is greater than that of the second part 134.

In some examples, the sizes of the first part 122 and the second part 124 of the radiator 120 are determined based on the intensity of the radiated energy in the direction θ_{opt.}, where the grating lobes are formed.

For example, once the spacing between the radiating elements in the antenna array is determined, the direction θ_{opt.}, where the grating lobes are formed, can be identified. By adjusting the sizes of the first part 122 and the second part 124 of the radiator 120, the radiating element 100 can be configured such that the intensity of the radiated energy in the direction θ_{opt.}, where the grating lobes are formed f(θ_{opt.}, φ) or the intensity of the radiated energy E(θ_{opt.}, φ) of the antenna array that includes the radiating element 100 in the direction θ_{opt.}, where the grating lobes are formed, is reduced to an acceptable level. This may depend on actual requirements. In general, the larger the first part 122 of the radiator 120 is compared to the second part 124, the more the intensity f(θ_{opt.}, φ) or E(θ_{opt.}, φ) is reduced, meaning that the radiation pattern f(θ, φ) of the radiating element 100 or the radiation pattern E(θ, φ) of the antenna array that includes the radiating element 100 will have a deeper concave in the direction θ_{opt.}

In addition, depending on the application scenario, the antenna may be installed at an inclined angle (i.e., the antenna is physically tilted to not extend vertically), thereby tilting the antenna patterns generated by the arrays of the antenna accordingly. For example, antennas are often installed with a physical downward tilt (towards the ground) to better cover a wide ground area, reduce interference from tall buildings or other obstacles, and improve the signal quality for ground-based equipment, among other benefits. Sometimes, antennas are alternatively installed with a physical upward tilt (towards the sky) to improve long-range coverage, reduce interference from ground-based equipment or people, and enhance the signal quality for high-altitude equipment, among other benefits. In some other cases, the radiating elements of an array may include fixed phase offsets that are designed to electronically tilt the radiation patterns generated by the array (i.e., the elevation angle where the radiation pattern has peak intensity is electronically adjusted). In still some other cases, antennas, such as remote electronic downtilt (RET) antennas are provided, that allow a cellular operator to set the amount of electronic tilt that is applied to the radiation pattern within a certain range of inclination angles (for example, from −2° to −12°).

If the antenna is physically installed at an inclined angle, and/or if an electronic tilt is applied to the radiation pattern, this will cause the direction θ_{opt.}, where the grating lobes are formed, to change as compared to when the antenna is installed vertically with no electronic tilt, for example, θ_{opt.} will shift in the direction of the tilt by the corresponding inclination angle. Therefore, the sizes of the first part 122 and the second part 124 of the radiator 120 can also be set based on the inclination angle or inclination angle range. It will be appreciated that herein references to the “inclination/tilt” or “inclination/tilt angle” cover both mechanical changes to the inclination angle (physical tilt) and electronic changes to the inclination angle (electronic tilt).

For an antenna with a downward tilt configuration, the radiating element 100 can be installed in the antenna such that the first side is the lower side and the second side is the upper side. In other words, when the antenna is in use, the first part 122 of the radiator 120 is located below the second part 124. In this case, the larger the first part 122 of the radiator 120 is compared to the second part 124, the more the EL beam of the radiating element 100 will tilt downward.

Similarly, for an antenna with an upward tilt configuration, the radiating element 100 can be installed in the antenna such that the first side is the upper side and the second side is the lower side. In other words, when the antenna is in use, the first part 122 of the radiator 120 is located above the second part 124. In this case, the larger the first part 122 of the radiator 120 is compared to the second part 124, the more the EL beam of the radiating element 100 will tilt upward.

The asymmetric design of the first part 122 and the second part 124 of the radiator 120 can provide better grating lobe suppression across a wide range of inclination angles. Typically, the size of the first part 122 and the second part 124 of the radiator 120 can be determined based on the maximum inclination angle in the inclination angle range, as the worst grating lobes tend to occur in situations with large tilt angles.

The size of the first part 132 and the second part 134 of the director 130 can be similarly determined, which will not be elaborated further here. It is not required that the ratio between the size of the first part 132 and the second part 134 of the director 130 be approximately equal to the ratio between the size of the first part 122 and the second part 124 of the radiator 120. The asymmetric design of the radiator 120 and the asymmetric design of the director 130 can be determined independently. In general, when the first part 122 of the radiator 120 is larger than the second part 124, the first part 132 of the director 130 located in front of the first part 122 of the radiator 120 can be larger than the second part 134 of the director 130 located in front of the second part 124 of the radiator 120, and vice versa. It should be understood that, as needed, the asymmetric design described here can be applied to either or both the radiator 120 and the director 130 of the radiating element 100.

FIG. 7 includes a schematic side view and a schematic front view of a radiating element 200 with a metasurface 240 according to some examples of the present disclosure. In some examples, as shown in section (A) of FIG. 7, the radiating element 200 includes a feeder pillar 210, a radiator 220 positioned at a front end of the feeder pillar 210, and the metasurface 240 positioned in front of the radiator 220. The feeder pillar 210 may be mechanically and electrically connected to the radiator 220 at a front end portion of the feeder pillar 210, so as to feed an RF signal to the radiator 220. For example, when the radiating element 200 is installed in the antenna, the feeder pillar 210 can extend a certain distance forward from the reflector, so that the radiator 220 is positioned approximately 0.15λ₀ to 0.35λ₀ forwardly of the reflector, such as being 0.25λ₀ away. It should be understood that the distance between the radiator 220 and the reflector can be set according to actual requirements, and no specific limitations are imposed on this herein.

The metasurface 240 may be a Partially Reflective Surface (PRS), also known as a Frequency Selective Surface (FSS), which can be configured to selectively reflect or transmit electromagnetic waves within a specific frequency range. The metasurface 240 may include multiple metasurface units arranged in a periodic pattern. These metasurface units may have subwavelength dimensions (i.e., smaller than the wavelength of the incident electromagnetic waves), enabling them to effectively manipulate electromagnetic waves (for example, reflecting or transmitting the incident electromagnetic waves in a specific manner) without causing noticeable physical scattering. By designing parameters such as the size, shape, and arrangement of the metasurface units (also referred to as the metasurface's design), the metasurface 240 can achieve various electromagnetic control functionalities. The metasurface may include various materials, such as metallic materials (e.g., gold, silver, copper, aluminum, etc.), dielectric materials (e.g., silicon, silicon nitride, aluminum nitride, etc.), and others. In some embodiments, a three-dimensional metamaterial structure may be used that includes metasurfaces that extend in non-parallel directions.

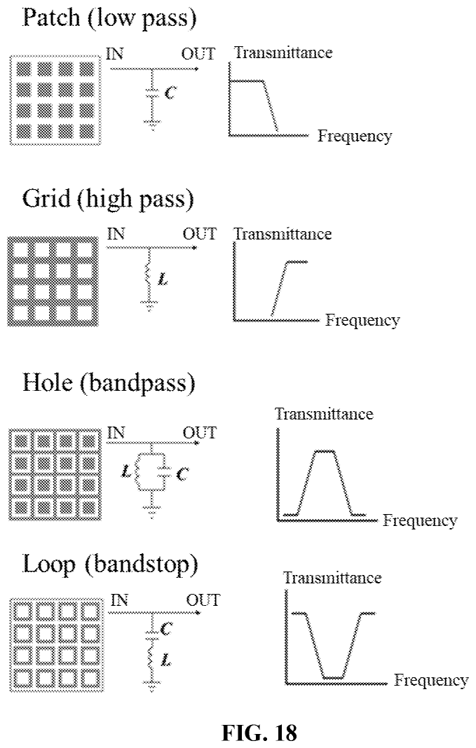

The working principle of the metasurface can be modeled using various approaches, such as a capacitor model that passes low frequencies and blocks high frequencies, an inductor model that passes high frequencies and blocks low frequencies, or an LC resonance model (such as a capacitor-inductor series model or a capacitor-inductor parallel model, etc.). For non-limiting illustrative purposes, FIG. 18 schematically shows various exemplary metasurface models, where the gray areas may represent metallic materials and the white areas may represent dielectric materials (which may be air). For patch-type metasurfaces, their equivalent circuit is composed of capacitors, allowing them to function as low-pass filters. For grid-type metasurfaces, their equivalent circuit is composed of inductors, allowing them to function as high-pass filters. For hole-type metasurfaces, their equivalent circuit consists of parallel capacitors and inductors, allowing them to function as band-pass filters. For loop-type metasurfaces, their equivalent circuit consists of series capacitors and inductors, allowing them to function as band-stop filters. Based on the corresponding working principles of the metasurface, the design of each part of the metasurface may be modified to adjust the distribution of equivalent capacitance and/or inductance. This, in turn, adjusts the reflection frequency range of each part of the metasurface, thereby regulating the reflection energy distribution of the metasurface. Specifically, the greater the overlap between the reflection frequency range of a certain part of the metasurface 240 and the operating frequency range of the radiating element 200, the stronger the reflection energy of that part of the metasurface 240.

The metasurface 240 can form a Fabry-Pérot (FP) cavity with the reflector, thereby enhancing the radiation emitted by the radiator 120 through resonance effects. Therefore, the cavity length of the FP cavity (i.e., the distance between the metasurface 240 and the reflector) can be designed based on λ₀ as the characteristic wavelength of the FP cavity. For example, but not limited to, the cavity length can be set to 0.5λ₀. It should be understood that the distance between the metasurface 240 and the reflector can be specifically set according to actual requirements, and no specific limitations are imposed on this herein.

In some other examples, as shown in section (B) of FIG. 7, the radiating element 200 may also include a director 230. The director 230 can be positioned in front of the radiator 220 and behind the metasurface 240. As a non-limiting example, the distance between the director 230 and the radiator 220 can be approximately 0.15λ₀, and the distance between the director 230 and the metasurface 240 can be approximately 0.1λ₀. It should be understood that the distance between the director 230 and the radiator 220 or the metasurface 240 can be specifically set according to actual requirements, and no specific limitations are imposed on this herein.

Subsequent examples of the present disclosure will be illustrated based on section (B) of FIG. 7, but this is merely exemplary and not restrictive. It should be understood that subsequent examples of the present disclosure are also applicable to the radiating element shown in section (A) of FIG. 7, where the director 230 is optional rather than required in these examples. Section (C) of FIG. 7 is a schematic front view of the radiating element 200 as shown in section (B) of FIG. 7 with the metasurface 240 removed. As shown in section (C) of FIG. 7, the radiator 220 and the director 230 of the radiating element 200 are symmetrical with respect to the plane A where the center of the feeder pillar 210 is located, respectively. It should also be understood that, in some examples, the asymmetric design described earlier for the radiator 120 and the director 130 of the radiating element 100 can be applied to either or both the radiator 220 and the director 230 of the radiating element 200, without further elaboration here.

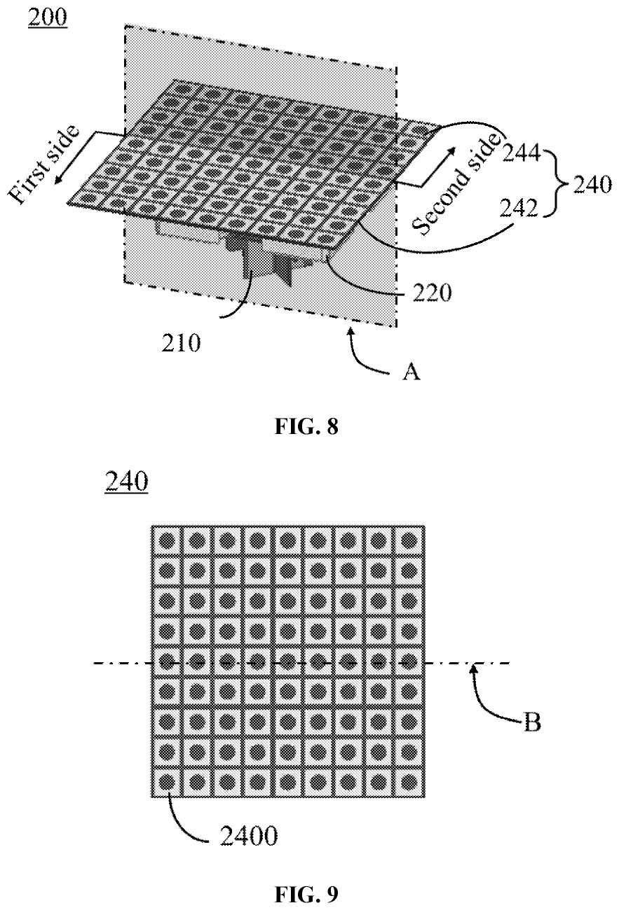

FIG. 8 is a schematic perspective view of the radiating element 200 shown in FIG. 7. FIG. 9 is a schematic front view of the metasurface 240 of the radiating element shown in FIGS. 7-8. As shown in FIG. 8, the metasurface 240 includes a first part 242 and a second part 244. A plane A is also shown in FIG. 8 that extends in a plane that is perpendicular to the plane defined by the metasurface 240. The plane A bisects the feeder pillar 210 of radiating element 200. With the plane A as the reference, the first part 242 of the metasurface 240 is positioned on the first side of the feeder pillar 210, and the second part 244 of the metasurface 240 is positioned on the second side of the feeder pillar 210. As shown in FIG. 9, the metasurface 240 may include multiple metasurface units 2400 arranged in a periodic pattern. In FIG. 9, the light gray portions represent metallic materials, and the dark gray portions represent dielectric materials and the dark gray regions are regions where no metallic materials are present. In the various figures of the present disclosure, the metasurface units are illustrated as patch-type, but this is merely exemplary and not restrictive. Unless specifically stated otherwise, the present disclosure does not impose any particular restrictions on the design of the metasurface.

The metasurface 240 can be configured such that the amount of energy reflected by the first part 242 of the metasurface 240 from the radiator 220 is greater than the amount of energy reflected by the second part 244 of the metasurface 240 from the radiator 220. The metasurface 240 can cause the elevation plane pattern of the radiating element 200 to tilt in a direction away from the direction θ_{opt.} and/or have a narrowed elevation beam width, thereby achieving grating lobe suppression. The following describes various exemplary configurations of the radiating element 200, where the amount of energy reflected by the first part 242 of the metasurface 240 from the radiator 220 is greater than the amount of energy reflected by the second part 244 of the metasurface 240 from the radiator 220.

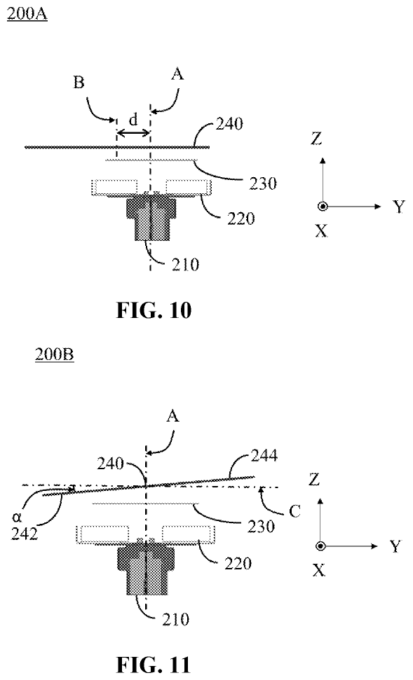

FIG. 10 is a schematic side view of a radiating element 200A, which includes an offset metasurface 240 according to some examples of the present disclosure. In some examples, as shown in FIG. 10, the metasurface 240 is offset by a distance in the direction of the first side of the feeder pillar 210 (i.e., the negative Y direction). For example, the center of the feeder pillar 210 is located in plane A, and the center of the metasurface 240 is located in plane B, where plane B is parallel to plane A. The distance d between plane A and plane B is the offset distance of the metasurface 240. The metasurface 240, when offset in this manner, creates a larger FP cavity area on the first side of the feeder pillar 210 (the left side as shown in FIG. 10) compared to the FP cavity area on the second side of the feeder pillar 210 (the right side as shown in FIG. 10). As a result, more radiation energy is reflected multiple times on the first side of the feeder pillar 210, leading to enhancement and convergence. This can redirect (specifically, tilt away from the direction, θ_{opt.}) and narrow the radiation beam of the radiator 220, ultimately reducing the directional coefficient of the elevation plane pattern at the direction θ_{opt.}, thereby achieving a grating lobe suppression effect.

In some examples, the metasurface 240 is parallel to the reflector. In this case, the FP cavity formed by the metasurface 240 and the reflector has a constant cavity length at various positions of the metasurface 240, which can be approximately 0.5λ₀. Due to the offset of the metasurface 240 towards the first side of the feeder pillar 210, a portion of the radiation energy emitted from the radiator 220 on the second side of the feeder pillar 210 may not be incident on the metasurface 240 and thus cannot be reflected by it. Instead, this portion of the radiation energy radiates outward directly, resulting in this radiation energy not undergoing the enhancement and convergence provided by the FP cavity. In contrast, in the space on the first side of the feeder pillar 210, most of the radiation energy emitted from the radiator 220 is likely to be incident on the metasurface 240, allowing it to be reflected by the metasurface 240 and undergo enhancement and convergence within the FP cavity.

Therefore, by controlling the offset distance d, the proportion of energy radiated outward in the space on both sides of the feeder pillar 210 can be adjusted, allowing for the redirection of the synthesized radiation beam. In some examples, the offset distance d is determined based on the intensity of the radiation energy in the direction θ_{opt.}, where the grating lobes are formed. For example, once the spacing between the radiating elements in the antenna array is determined, the direction θ_{opt.}, where the grating lobes are formed, can be identified. The offset distance d of the metasurface 240 may be adjusted so that the intensity of the radiation energy f(θ_{opt.}, φ) of the radiating element 200A in the direction θₒₚₜ, where the grating lobes are formed, or the intensity of the radiated energy E(θ_{opt.}, φ) of the antenna array that includes the radiating element 100 in the direction θ_{opt.}, where the grating lobes are formed, is reduced to an acceptable level. This may depend on actual requirements. Generally, the larger the offset distance d of the metasurface 240, the more (θ_{opt.}, φ) or E(θ_{opt.}, φ) decreases, i.e. f(θ, φ) or E(θ, φ) at θ_{opt.} will have a deeper concave in the direction θ_{opt.}

Additionally, since the antenna is physically installed at an inclined angle and/or the generated radiation pattern is applied with an electronic tilt, this will cause the direction θ_{opt.}, where the grating lobes are formed, to change compared to when the antenna is installed vertically with no electronic tilt, the offset distance d of the metasurface 240 can also be set based on the inclination angle or inclination angle range. For an antenna with a downward tilt configuration, the radiating element 200A can be installed in the antenna such that the aforementioned first side is the lower side and the aforementioned second side is the upper side, meaning that when the antenna is in use, the metasurface 240 is offset downward. Similarly, for an antenna with an upward tilt configuration, the radiating element 200A can be installed in the antenna such that the aforementioned first side is the upper side and the aforementioned second side is the lower side, meaning that when the antenna is in use, the metasurface 240 is offset upward.

The appropriate offset distance d may achieve good grating lobe suppression over a wide range of inclination angles. Typically, the offset distance d of the metasurface 240 can be determined based on the maximum inclination angle within the inclination angle range, as the worst grating lobes tend to occur in situations with larger inclination angles. In some examples, the offset distance d of the metasurface 240 is adjustable. For example, when the inclination angle changes, or when it is necessary to adjust the level of grating lobe suppression, the offset distance d of the metasurface 240 can be adjusted using a drive mechanism, such as a motor.

FIG. 11 is a schematic side view of a radiating element 200B, which includes a rotating metasurface 240, according to some examples of the present disclosure. In some examples, the metasurface 240 is rotated by an angle around a second direction (i.e., the X direction), which is transverse to the first direction (i.e., the Y direction). The first direction extends from the first side of the feeder pillar 210 to the second side of the feeder pillar 210.

As shown in FIG. 11, the metasurface 240 can be rotated by an angle in such a way that the first part 242 of the metasurface 240 is closer to the radiator 220, while the second part 244 of the metasurface 240 is farther from the radiator 220 (i.e., rotated counterclockwise along the X direction as shown in FIG. 11). For example, a plane C is a plane that is perpendicular to plane A which is the plane passing through the center of the feeder pillar 210. It should be understood that when the antenna is installed vertically, plane C is also the vertical plane perpendicular to the ground. The rotation angle of the metasurface 240 can be defined as the angle α between the metasurface 240 and the plane C. The metasurface 240, when rotated in this manner, can be designed such that the distance between the metasurface 240 and the reflector on the first side of the feeder pillar 210 (the left side shown in FIG. 11) corresponds to a FP cavity with a characteristic wavelength of approximately λ₀. For instance, this distance can be around 0.5λ₀, thereby enhancing and converging the radiated energy from the radiator 220 through multiple reflections. The distance between the metasurface 240 on the second side of the feeder pillar 210 (the right side in FIG. 11) and the reflector can be designed such that the FP cavity formed with the reflector on the second side deviates from the characteristic wavelength λ₀. For example, it can be greater than 0.5λ₀, which results in little or no enhancement or convergence of the radiation energy from the radiator 220.

It should be understood that, when space allows (for example, without conflicting with the radiator 220 and the reflector 230, if present), the metasurface 240 can also be rotated by an angle in such a way that the first part 242 of the metasurface 240 is farther from the radiator 220, while the second part 244 of the metasurface 240 is closer to the radiator 220 (i.e., rotated clockwise along the X direction as shown in FIG. 11). The metasurface 240, when rotated in this manner, can be designed such that the distance between the metasurface 240 and the reflector on the first side of the feeder pillar 210 (the left side shown in FIG. 11) corresponds to a FP cavity with a characteristic wavelength of approximately λ₀. For instance, this distance can be around 0.5λ₀, thereby enhancing and converging the radiated energy from the radiator 220 through multiple reflections. The distance between the metasurface 240 on the second side of the feeder pillar 210 (the right side in FIG. 11) and the reflector can be designed such that the FP cavity formed with the reflector on the second side deviates from the characteristic wavelength λ₀. For example, it can be greater than 0.5λ₀, which results in little or no enhancement or convergence of the radiation energy from the radiator 220.

Therefore, by controlling the rotation angle α to adjust the distances between the metasurface 240 and the reflector on both sides of the feeder pillar 210, the proportion of energy radiated outward from the spaces on both sides of the feeder pillar 210 can be adjusted. This allows for the redirection (specifically, tilting away from the direction of θ_{opt.}), and narrowing of the synthesized radiation beam, ultimately reducing the directional coefficient of the elevation plane pattern at θ_{opt.}, thereby achieving a grating lobe suppression effect.

In some examples, the rotation angle α is determined based on the intensity of the radiation energy in the direction θ_{opt.}, where the grating lobes are formed. For example, once the spacing between the radiating elements in the antenna array is determined, the direction θ_{opt.}, where the grating lobes are formed, can be identified. The rotation angle α of the metasurface 240 may then be adjusted so that the intensity of the radiation energy f(θ_{opt.}, φ) of the radiating element 200B is in the direction θ_{opt.}, where the grating lobes are formed, or the intensity of radiation energy E(θ_{opt.}, φ) of the antenna array that includes the radiating element 200B in the direction θ_{opt.}, where the grating lobes are formed, is reduced to an acceptable level. This may depend on actual requirements. In general, the rotation angle α of the metasurface 240 is increased to cause the characteristic wavelengths of the FP cavity at the first side of the feeder pillar 210 to be closer to λ₀, and the more the characteristic wavelengths of the FP cavity at the second side of the feeder pillar 210 deviates from λ₀, the more the f(θ_{opt.}, φ) or E(θ_{opt.}, φ) decreases, i.e., f(θ, φ) or E(θ, φ) will be reduced in the direction θ_{opt.}.

Additionally, since the antenna beams may be configured to have a physical or an electronic tilt from 0° (e.g., a downtilt or an uptilt), this will cause the direction θ_{opt.}, where the grating lobes are formed, to change compared to when the antenna beams are directed at an elevation angle of 0°, the rotation angle α of the metasurface 240 can also be set based on the inclination (elevation) angle or inclination angle range of the generated radiation patterns. The appropriate rotation angle α can achieve good grating lobe suppression over a wide range of inclination angles. Typically, the rotation angle α of the metasurface 240 can be determined based on the maximum inclination angle within the inclination angle range, as the worst grating lobes tend to occur in situations with larger inclination angles. In some examples, the rotation angle α of the metasurface 240 may be adjustable. For example, when the inclination angle changes, or when it is necessary to adjust the level of grating lobe suppression, the rotation angle α of the metasurface 240 can be adjusted using a drive mechanism, such as a motor.

It should be understood that although metasurface 240 in the example of FIG. 10 is merely offset and not rotated and in the example of FIG. 11 is merely rotated and not shifted, these examples may be combined. The offset and rotation of the metasurface 240 can each contribute to a certain degree of grating lobe suppression, thereby collectively suppressing the grating lobes to an acceptable level. Therefore, the offset distance d and rotation angle α of the metasurface 240 can be determined together based on the intensity of the radiated energy in the direction θ_{opt.}, where the grating lobes are formed.

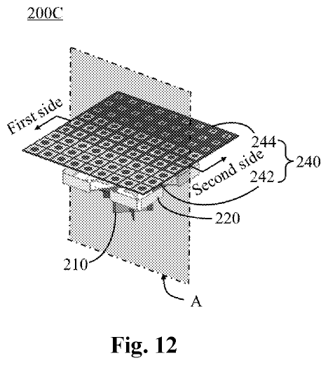

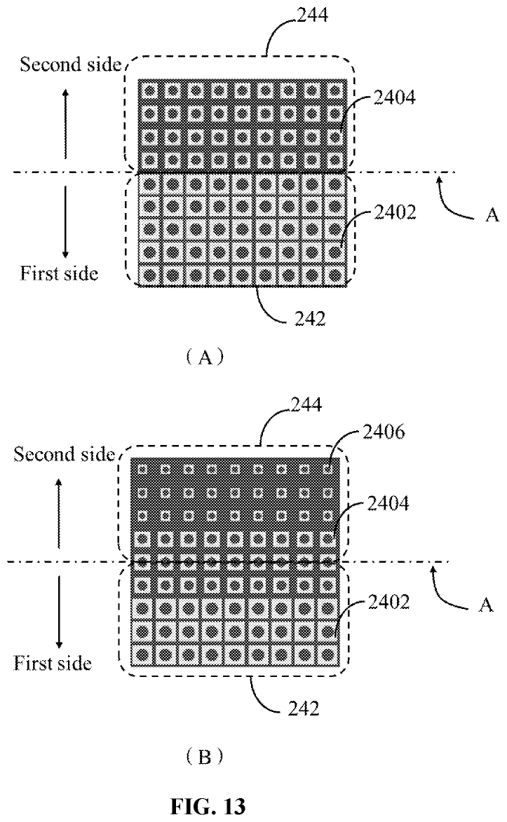

FIG. 12 is a schematic perspective view of a radiating element 200C with an asymmetric metasurface 240 according to some examples of the present disclosure. FIG. 13 are front views of two example asymmetric metasurfaces 240 according to some examples of the present disclosure that can be used, for example, in the radiating element 200C of FIG. 12.

An asymmetric metasurface 240 refers to a metasurface that has a first part 242 and a second part 244 that have different designs. For example, they can differ in at least one aspect among several aspects, such as the size, shape, arrangement (e.g., periodicity), materials, etc., of the metasurface units 2400. The present disclosure aims to make the amounts of energy reflected by the first part 242 and the second part 244 of the metasurface 240, which come from the radiator 220, different by employing different metasurface designs. It should be understood that although some implementations of the asymmetric metasurface 240 are described below by way of examples, these are not restrictive. The first part 242 and the second part 244 of the asymmetric metasurface 240 can each adopt any appropriate design, as long as it ensures that the amount of energy reflected by the first part 242 of the metasurface 240 from the radiator 220 is greater than the amount of energy reflected by the second part 244 of the metasurface 240 from the radiator 220.

In some examples, the first part 242 of the metasurface 240 includes multiple first metasurface units arranged periodically, and the second part 244 of the metasurface 240 includes multiple second metasurface units arranged periodically, where the first metasurface units are different from the second metasurface units. Based on the working principle explained earlier in relation to FIG. 18, it should be understood that by adjusting parameters such as the size, shape, and arrangement of the metasurface units, the equivalent capacitance and/or equivalent inductance of the multiple first metasurface units and the multiple second metasurface units may be adjusted in such a way that the amount of energy reflected by the first part 242 of the metasurface 240 from the radiator 220 is greater than the amount of energy reflected by the second part 244 of the metasurface 240 from the radiator 220. In some examples, the equivalent capacitance of the multiple first metasurface units is greater than the equivalent capacitance of the multiple second metasurface units. Additionally or alternatively, in some examples, the equivalent inductance of the multiple first metasurface units is greater than the equivalent inductance of the multiple second metasurface units.

Specifically, the periodic arrangement of the multiple first metasurface units (i.e., the design of the first part 242 of metasurface 240) and the periodic arrangement of the multiple second metasurface units (i.e., the design of the second part 244 of metasurface 240) can be determined based on the intensity of the radiated energy in the direction θ_{opt.}, where the grating lobes are formed. By controlling the design of the first part 242 and the second part 242 of metasurface 240, the equivalent capacitance/inductance distribution of metasurface 240 can be adjusted to modify its reflected energy distribution. This, in turn, may redirect the elevation plane pattern of radiating element 200C to suppress its directivity coefficient θ_{opt.} The more energy reflected by the first part 242 of metasurface 240 compared to the second part 242, the more pronounced the asymmetry in the energy radiated outward in the space on both sides of the feeder pillar 210. As a result, the radiating element pattern is deflected more in the direction away from θ_{opt.}, leading to a better grating lobe suppression effect.

In some examples, at least one of the shape, size, and periodicity of the plurality of first metasurface units may differ from the corresponding at least one of the shape, size, and periodicity of the plurality of second metasurface units. In some examples, the shape of the first metasurface unit may differ from the shape of the second metasurface unit, such as one being a patch-type and the other being a loop-type. In some examples, the first and second metasurface units may have the same shape but have different sizes and/or periods.

For example, as shown in the (A) portion of FIG. 13, the first part 242 of the metasurface 240 includes a plurality of the first metasurface units 2402 that are arranged periodically, and the second part 244 of the metasurface 240 includes a plurality of second metasurface units 2404 that are arranged periodically. These metasurface units have the same shape and period, and the size of the first metasurface unit 2402 is larger than the size of the second metasurface unit 2404. For the patch-type metasurface (which is composed of capacitors with equivalent circuitry) as shown in FIG. 13, the larger the size of the metasurface unit, the larger the equivalent capacitance is, in the case of other conditions being the same. Accordingly, by controlling the size of the various metasurface units of the metasurface 240, the equivalent capacitance distribution of the metasurface 240 may be adjusted, thereby adjusting the reflected energy distribution of the metasurface 240. In the example shown in the (A) portion of FIG. 13, the equivalent capacitance of the first part 242 of the metasurface 240 is greater than the equivalent capacitance of the second part 244 of the metasurface 240, such that the amount of energy reflected from the radiator 220 by the first part 242 of the metasurface 240 is greater than the amount of energy reflected from the radiator 220 by the first part 242 of the metasurface 240. As the first part 242 of the metasurface 240 reflects more energy, more energy in the space on the first side of the feeder pillar 210 is enhanced and converged by multiple reflections.

Thus, by controlling the sizes of the first metasurface unit 2402 and second metasurface unit 2404 to control the proportions of the metasurface 240 between the equivalent capacitance of the two sides of the feeder pillar 210, a ratio of the energy that eventually radiates outwardly in the space of the two sides of the feeder pillar 210 may be adjusted to redirect (specifically, tilt in a direction away from θ_{opt.}), and narrowing of the synthesized radiation beam, ultimately reducing the directional coefficient of the elevation plane pattern at θ_{opt.}, thereby achieving a grating lobe suppression effect.

In some examples, the sizes of the first and second metasurface units 2402 and 2404 are determined based on the intensity of the radiated energy in the direction θ_{opt.}, where the grating lobes are formed. For example, once the spacing between the radiating elements in the antenna array is determined, the direction θ_{opt.}, where the grating lobes are formed, can be identified. The sizes of the first metasurface unit 2402 and second metasurface unit 2404 of the metasurface 240 are designed such that the intensity of the radiated energy f(θ_{opt.}, φ) of the radiating element 200C in the direction θₒₚₜ, where the grating lobes are formed, or the intensity of the radiated energy E E(θ_{opt.}, φ) of the antenna array comprising the radiating element 200C at the direction θ_{opt.}, where the grating lobes are formed, is reduced to an acceptable level. This may depend on actual requirements. Additionally, since the generated radiation pattern may have a physical or electronic inclination angle, this will cause the direction θ_{opt.}, where the grating lobes are formed, to change compared to when the generated radiation pattern does not have any inclination, it may also set the sizes of the first metasurface unit 2402 and the second metasurface unit 2404 of the metasurface 240 based on the inclination angle or inclination angle range. The appropriate metasurface unit size may achieve good grating lobe suppression over a wide range of inclination angles. Typically, the metasurface unit size may be determined based on the maximum inclination angle within the inclination angle range, as the worst grating lobes tend to occur in situations with larger inclination angles.

Of course, the metasurface 240 may also be included in three or more sets of metasurface units to achieve finer adjustment of the reflected energy distribution. As shown in the (B) portion of FIG. 13, the metasurface 240 includes a plurality of first metasurface units 2402 in a periodic arrangement, a plurality of second metasurface units 2404 in a periodic arrangement, and a plurality of third metasurface units 2406 in a periodic arrangement. These metasurface units have the same shape and period, and the size of the first metasurface unit 2402 are larger than the size of the second metasurface unit 2404, and the size of the second metasurface unit 2404 are larger than the size of the third metasurface unit 2406 such that equivalent capacitance of the metasurface 240 is progressively reduced from the first side to the second side, thereby the reflected energy thereof is also progressively reduced from the first side to the second side.

It should be understood that although the above described example of adjusting the reflected energy distribution of the metasurface 240 by controlling the size of the patch-type metasurface unit in a manner that adjusts the equivalent capacitance distribution, this is not limiting, and the arrangement (e.g., period), shape, material, etc. of the metasurface unit can be additionally or alternatively adjusted for one or more parameters to synergistically adjust the equivalent capacitance and/or inductance distribution of the desired metasurface 240.

Since the design of the metasurface is not easy to change after manufacturing is complete, in order to flexibly adjust the reflective energy distribution of the metasurface 240, a lumped element may also be provided in the metasurface 240 to adjust the reflective energy distribution of the metasurface 240 by changing the inductance value and/or capacitance value of the total element by control signals, which provides a partially reflective surface that may be reconstituted.

These lumped elements, for example, can individually or in combination with the metasurface units, be equivalently configured as a pure capacitor, a pure inductor, or a series and/or parallel circuit of a hybrid capacitor and inductor. As a non-limiting example of a lumped capacitor, a varactor diode may be used to implement a lumped element with adjustable capacitance, where the capacitance value can be adjusted by changing the reverse bias voltage with an electrical signal. Additionally, a Micro-Electro-Mechanical System (MEMS) capacitor can be used to implement a lumped element with adjustable capacitance, where the capacitance value can be adjusted by controlling the plate distance or area through electrostatic or thermal driving methods. Furthermore, ferroelectric materials can be used as the dielectric medium to implement a lumped element with adjustable capacitance, where the capacitance value can be adjusted by applying an external electric field via an electrical signal. As a non-limiting example of a lumped inductor, an adjustable core inductor coil can be used to implement a lumped element with adjustable inductance, where the inductance value can be adjusted by controlling the core position through mechanical or electromagnetic methods with a control signal. Additionally, a MEMS inductor can be used to implement a lumped element with adjustable inductance, where the inductance value can be adjusted by controlling the structural displacement of the inductor coil or the magnetic circuit properties with a control signal.

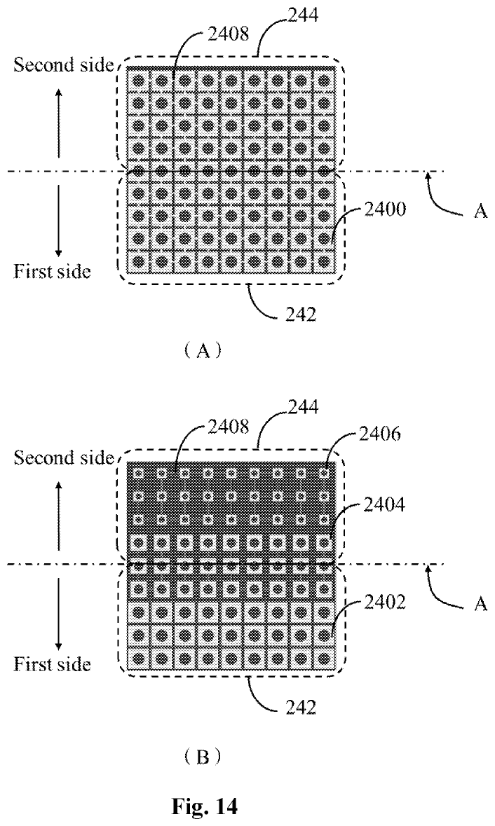

FIG. 14 provides front views of two example configurations of a metasurface 240 that includes lumped elements 2408, according to some examples of the present disclosure. In some examples, the metasurface 240 may include a plurality of periodically arranged metasurface units 2400 and a plurality of lumped elements 2408 arranged between the metasurface units 2400. The inductance value and/or capacitance value of each lumped element 2408 is adjustable. Although each part of the metasurface 240 has the same design (with metasurface units 2400 having the same shape, period, and size parameters, etc.), meaning that the equivalent capacitance and/or inductance provided by each metasurface unit itself (in the case of the patch-type metasurface shown in FIG. 14, the metasurface units provide equivalent capacitance) are the same, the inductance value and/or capacitance value of each lumped element can be adjusted such that the amount of energy reflected by the first part 242 of the metasurface 240, which is reflected from the radiating element 220, is greater than the amount of energy reflected by the second part 244 of the metasurface 240 from the radiating element 220. For example, the capacitance value of the lumped elements 2408 in the first part 242 of the metasurface 240 can be made greater than the capacitance value of the lumped elements 2408 in the second part 244 of the metasurface 240. Additionally or alternatively, the inductance value of the lumped elements 2408 in the first part 242 of the metasurface 240 can be made greater than the inductance value of the lumped elements 2408 in the second part 244 of the metasurface 240. In this way, more energy can be reflected by the metasurface 240 on the first side of the feeder pillar 210, while more energy can be transmitted through the metasurface 240 on the second side of the feeder pillar 210.

Thus, by controlling the inductance value and/or capacitance value of the various lumped elements 2408 to control the equivalent inductance distribution and/or equivalent capacitance distribution of the metasurface 240 on both sides of the feeder pillar 210, a ratio of the energy that eventually radiates outwardly in the space of both sides of the feeder pillar 210 may be adjusted to redirect (specifically tilt towards away from the direction θ_{opt.}) and narrow the synthesized radiation beam, ultimately reducing the directional coefficient of the elevation plane pattern at θ_{opt.}, thereby achieving a grating lobe suppression effect.

In some examples, the inductance value and/or capacitance value for each of the lumped elements 2408 are determined based on the intensity of the radiated energy in the direction θₒₚₜ, where the grating lobes are formed. For example, once the spacing between the radiating elements in the antenna array is determined, the direction θₒₚₜ, where the grating lobes are formed, can be identified. By controlling the inductance value and/or capacitance value of each of the lumped elements 2408, the intensity of the radiated energy f(θ_{opt.}, φ) of the radiating element at the direction θ_{opt.}, where the grating lobes are formed, or the intensity of the radiated energy E(θ_{opt.}, φ) of the antenna array comprising a radiating element at the direction θ_{opt.}, where the grating lobes are formed, is reduced to an acceptable level. This may depend on actual requirements. Additionally, since the antenna may be configured so that the radiation patterns are inclined, this may cause the direction θ_{opt.}, where the grating lobes are formed, to change compared to the case when the radiation patterns are not inclined, inductance value and/or capacitance value of each lumped element 2408 can also be set based on the inclination angle or inclination angle range. Appropriate lumped inductance and/or lumped capacitance can provide better grating lobe suppression across a wide range of inclination angles.

Additionally, as shown in part (B) of FIG. 14, even if the metasurface 240 has an asymmetric design, lumped elements 2408 can be provided to enable flexible adjustment of the reflected energy distribution of the metasurface 240.

It should be understood that the metasurface 240 with an asymmetric design and/or lumped elements can also be shifted and/or rotated in accordance with the aforementioned examples. The offset, rotation, asymmetric design, and lumped elements of the metasurface 240 can each contribute to a certain degree of grating lobe suppression, collectively reducing the grating lobe level to an acceptable level.

On the other hand, the present disclosure provides an antenna array, which includes a plurality of radiating elements according to any of the examples described in the present disclosure. In some examples, the spacing between each radiating element in the antenna array is between 0.5 times and 1.5 times the wavelength λ₀ corresponding to the center frequency of the frequency range in which the radiating elements are configured to operate. For example, it can be between 0.8λ₀ and 1λ₀. Such an antenna array can enjoy the advantages of a larger inter-element spacing, such as higher radiation efficiency, better isolation performance, and lower manufacturing costs, while avoiding the adverse effects of strong grating lobes. In general, the spacing between each radiating element in the antenna array can be the same. In some cases, different inter-element spacings can also be set according to actual needs.

On the other hand, the present disclosure also provides an antenna that includes a radiating element according to any of the examples described in the present disclosure or an antenna array according to any of the examples described in the present disclosure. In some examples, the antenna is configured to generate radiation patterns that are downtilted. In this case, when the radiating element is installed in the antenna, the first side is configured as the lower side, and the second side is configured as the upper side. In some other examples, the antenna is configured to generate radiation patterns that are uptilted. In this case, when the radiating element is installed in the antenna, the first side is configured as the upper side, and the second side is configured as the lower side.

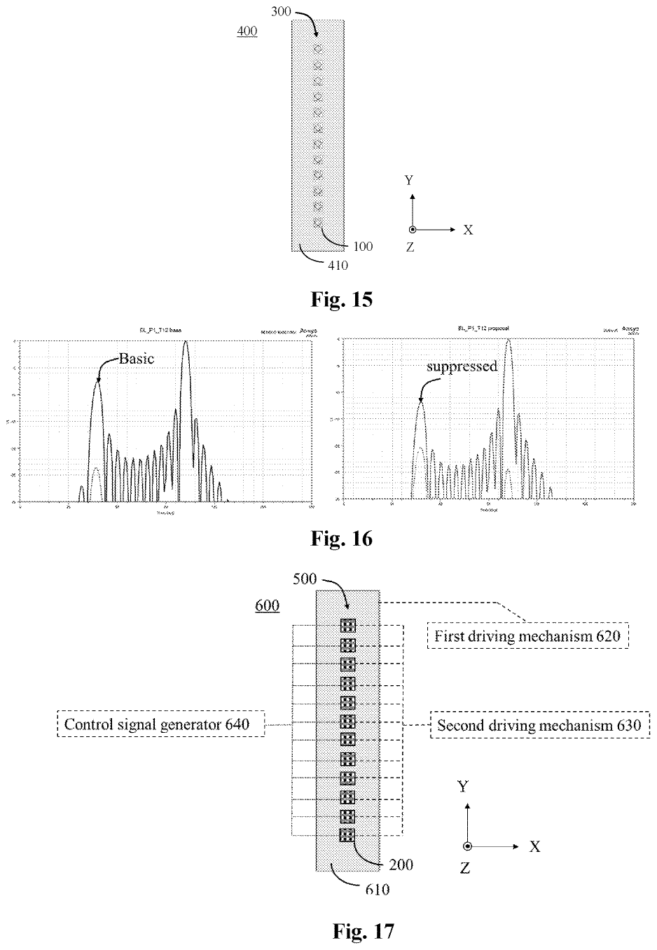

FIG. 15 is a schematic a front view of an antenna 400 according to some examples of the present disclosure. As shown in FIG. 15, the antenna 400 includes the antenna array 300, which comprises multiple radiating elements 100 (as shown in FIG. 4) with asymmetric radiators and asymmetric directors. These radiating elements 100 are mounted forward of the reflector 410 and are arranged in the Y-direction. FIG. 16 shows an elevation plane pattern (right) of the antenna 400 shown in FIG. 15 and an elevation plane pattern (left) for an antenna including a conventional radiating element of a symmetric radiator and a symmetric director. It may be seen that after using the array element proposed in this disclosure, the grating lobe level of the antenna array is suppressed by approximately 4.3 dB.

On the other hand, the present disclosure also provides a RET antenna, including: a reflector; a radiating element mounted in front of the reflector, where the radiating element is the radiating element as described in any of the examples of the present disclosure and is part of an array of radiating elements; and a first driving mechanism configured to adjust an electronic inclination angle of radiation patterns generated by the array of radiating elements. In some examples where the radiating element includes a metasurface, the RET antenna may further include a second driving mechanism configured to, in response to the adjustment of the electronic inclination angle, offset the metasurface of the radiating element in a first direction parallel to the reflector, and/or rotate the metasurface of the radiating element around a second direction that is parallel to the reflector and perpendicular to the first direction. In some examples where the radiating element includes a metasurface with lumped elements, the RET antenna may further include a control signal generator configured to, in response to the adjustment of the electronic inclination angle, generate a control signal to adjust the inductance value and/or capacitance value of the lumped elements in the metasurfaces of the radiating elements.

FIG. 17 is a schematic front view of a RET antenna 600 according to some examples of the present disclosure, where the long dashed lines indicate mechanical connections, and the short dashed lines indicate electrical connections. The RET antenna 600 may include a reflector 610 and a plurality of radiating elements 200 mounted in front of the reflector 610 (in the Z-direction). These radiating elements 200 are arranged in the Y-direction, forming an antenna array 500. The RET antenna 600 may include a first driving mechanism 620, such as a motor, that allows the inclination angle of the radiation patterns generated by the antenna array 500 to be remotely and electronically adjusted.

As mentioned earlier, when the antenna is physically tilted or the inclination angle of the generated radiation patterns is electronically adjusted, the direction θ_{opt.}, where the grating lobes are formed, changes compared to when the antenna is mounted vertically and has no electronic downtilt or uptilt. Therefore, the RET antenna 600 may include a second driving mechanism 630, such as a motor, to perform at least one of the following: The metasurface of each of the radiating elements 200 is shifted in the Y direction; or the metasurface of each of the radiating elements is rotated about the X direction. In this way, even if the direction θ_{opt.}, where the grating lobes are formed, changes, the radiation beam can be redirected by offsetting and/or rotating the metasurface in the direction away from the new θ_{opt.}, thereby reducing the directional coefficient at the new θ_{opt.}.

The second driving mechanism 630 can be a device capable of controlling both the translation and rotation of the metasurface, or it can include a first device for controlling the translation motion of the metasurface and a second device for controlling the rotation motion of the metasurface. Additionally, a separate second driving mechanism 630 can be provided for the metasurface of each radiating element 200 to independently control the movement of the metasurface of that radiating element 200. Alternatively, multiple radiating elements 200 can have their metasurface movements controlled collectively by a single second driving mechanism 630 through the use of transmission mechanisms or other means. For example, assuming the Y-direction is the direction from the ground towards the sky, when the electronic downtilt angle of the RET antenna 600 occurs or increases, the second driving mechanism 630 can be used to offset the metasurfaces of each radiating element 200 along the negative Y-direction and/or rotate them counterclockwise around the X-direction (with the thumb pointing in the X-direction and the other four fingers curling in the direction of rotation). Similarly, when the electronic uptilt angle of the RET antenna 600 occurs or increases, the second driving mechanism 630 can be used to offset the metasurfaces of each radiating element 200 along the Y-direction and/or rotate them clockwise around the X-direction (with the left thumb pointing in the X-direction and the other four fingers curling in the direction of rotation).

Additionally or alternatively, when the metasurface of the radiating element 200 includes lumped elements, the tilt can also be addressed by adjusting the lumped capacitance and/or lumped inductance. Specifically, the RET antenna 600 may include a control signal generator 640 for generating control signals to adjust the inductance value and/or capacitance value of the lumped elements. For example, when the electronic downtilt angle of the RET antenna 600 occurs or increases, the control signal generator 640 can generate and supply control signals to the lumped elements of the metasurface of each radiating element 200. This causes the capacitance value of one or more lumped elements located on the lower side of the feeder pillar to increase (and/or inductance value increase), and/or the capacitance value of one or more lumped elements located on the upper side of the feeder pillar to decrease (and/or inductance value decrease). Similarly, when the electronic uptilt angle of the RET antenna 600 occurs or increases, the control signal generator 640 can generate and supply control signals to the lumped elements of the metasurface of each radiating element 200. This causes the capacitance value of one or more lumped elements located on the lower side of the feeder pillar to decrease (and/or inductance value decrease), and/or the capacitance value of one or more lumped elements located on the upper side of the feeder pillar to increase (and/or inductance value increase). In this way, even if the direction θ_{opt.}, where the grating lobes are formed, changes, the radiation beam can be redirected by adjust the lumped capacitance/inductance distribution away from the direction θ_{opt.}, thereby reducing the directional coefficient at the new θ_{opt.}

It should be understood that the above-mentioned second driving mechanism 630 and/or control signal generator 640 can also be applied to other types of antennas, aside from the RET antenna (e.g., but not limited to, phased array antennas that require large-angle scanning), in order to flexibly achieve grating lobe suppression.

The terms “left”, “right”, “front”, “rear”, “top”, “bottom”, “upper”, “lower”, “high”, “low” in the Specification and Claims, if present, are used for descriptive purposes and not necessarily used to describe constant relative positions. It should be understood that the terms used in this way are interchangeable under appropriate circumstances, so that the examples of the present disclosure described herein, for example, can operate on other orientations that differ from those orientations shown herein or otherwise described. For example, when the device in the attached drawings is turned upside down, features that were originally described as “above” other features can now be described as “below” other features. The device may also be oriented by other means (rotated by 90 degrees or at other locations), in which case the relative spatial relationships will be explained accordingly.

In the Specification and the Claims, when an element is referred to as being “above” another element, “attached” to another element, “connected” to another element, “coupled” to another element, or “in contact with” another element, the element may be directly above another element, directly attached to another element, directly connected to another element, directly coupled to another element, or directly in contact with another element, or there may be one or a plurality of intermediate elements. In contrast, if an element is described as “directly” “above” another element, “directly attached” to another element, “directly connected” to another element, “directly coupled” to another element or “directly in contact with” another element, there will be no intermediate elements. In the Specification and Claims, a feature that is arranged “adjacent” to another feature may denote that a feature has a part that overlaps an adjacent feature or a part located above or below the adjacent feature.

As used herein, the word “exemplary” means “serving as an example, instance, or illustration” rather than as a “model” to be copied exactly. Any implementation method described exemplarily herein may not be necessarily interpreted as being preferable or advantageous over other implementation methods. Moreover, the present disclosure is not limited by any expressed or implied theory given in the technical field, background art, summary of the invention, or specific examples.

As used herein, the word “substantially” means comprising any minor changes caused by design or manufacturing defects, device or component tolerances, environmental influences, and/or other factors. Generally, the terms “about” and “substantially” as used herein mean within 10% greater or less than the stated value or value range, or within 10% of the complete condition or state. For example, “about 30%” or “substantially equal to 30%” can mean a proportion between 27% and 33%. The term also refers to variations that would be recognized by those skilled in the art as equivalents, provided that such variations do not encompass known values practiced by the prior art. The word “substantially” also allows for differences from the perfect or ideal situation due to parasitic effects, noise, and other practical considerations that may be present in the actual implementation.

In addition, for reference purposes only, “first”, “second” and similar terms may also be used herein, and thus are not intended to be limiting. For example, unless clearly indicated by the context, the words “first”, “second” and other such numerical words involving structures or elements do not imply a sequence or order. It should also be understood that when the term “include/comprise” is used herein, it indicates the presence of the specified feature, entirety, step, operation, unit and/or component, but does not exclude the presence or addition of one or more other features, entireties, steps, operations, units and/or components and/or combinations thereof.

In the present disclosure, the term “provide” is used in a broad sense to cover all manners of obtaining an object, so “providing an object” includes but is not limited to “purchase”, “preparation/manufacturing”, “arrangement/setting”, “mounting/assembly”, and/or “ordering” of the object, etc.

As used herein, the term “and/or” comprises any and all combinations of one or more of the associated listed items. The terms used herein are only for the purpose of describing specific examples and are not intended to limit the present disclosure. As used herein, the singular forms “a”, “an” and “the” are also intended to include the plural forms, unless the context clearly dictates otherwise.

Those skilled in the art should realize that the boundaries between the above operations are merely illustrative. A plurality of operations can be combined into a single operation, which may be distributed among additional operations, and the operations can be executed at least partially overlapping in time. Also, alternative examples may include a plurality of instances of specific operations, and the order of operations may be changed in various other examples. However, other modifications, changes and substitutions are also possible. Aspects and elements of all examples disclosed above may be combined in any manner and/or in conjunction with aspects or elements of other examples to provide a plurality of additional examples. Therefore, the Specification and attached drawings hereof should be regarded as illustrative rather than limiting.

Although some specific examples of the present disclosure have been described in detail through examples, those skilled in the art should understand that the above examples are only for illustration rather than for limiting the scope of the present disclosure. The examples disclosed herein can be combined arbitrarily without departing from the spirit and scope of the present disclosure. Those skilled in the art should also understand that various modifications may be made to the examples without departing from the scope and spirit of the present disclosure. The scope of the present disclosure is defined by the attached claims.

1. A radiating element, including:
a feeder pillar; and
a radiator positioned at the front end of the feeder pillar, the radiator comprising a first part located on a first side of the feeder pillar and a second part located on a second side of the feeder pillar opposite the first side, wherein the size of the first part of the radiator is larger than the size of the second part.

2. The radiating element according to claim 1, wherein the first part and the second part of the radiator have the same shape.

3. The radiating element according to claim 1, wherein the sizes of the first part and the second part of the radiator are determined based on the intensity of the radiated energy in the direction in which grating lobes are formed in the antenna array where the radiating element is arranged.

4. The radiating element according to claim 1, further comprising:
a director positioned in front of the radiator, the director comprising a first part located on the first side of the feeder pillar and a second part located on the second side of the feeder pillar, wherein the size of the first part of the director is larger than the size of the second part.

5. (canceled)

6. The radiating element according to claim 4, wherein the sizes of the first part and the second part of the director are determined based on the intensity of the radiated energy in the direction in which grating lobes are formed in the antenna array where the radiating element is arranged.

7. The radiating element according to claim 1, further comprising:
a metasurface positioned in front of the radiator, the metasurface comprising a first part located on the first side of the feeder pillar and a second part located on the second side of the feeder pillar,
wherein the metasurface is configured to perform at least one of the following:
the metasurface is offset by a distance in the direction of the first side of the feeder pillar relative to the feeder pillar; or
the metasurface is rotated by an angle around a second direction transverse to a first direction, where the first direction points from the first side of the feeder pillar to the second side of the feeder pillar; or
the first part of the metasurface comprises a plurality of first metasurface units arranged periodically, and the second part of the metasurface comprises a plurality of second metasurface units arranged periodically, wherein the plurality of first metasurface units and the plurality of second metasurface units are configured such that the amount of energy from the radiator reflected by the plurality of first metasurface units is greater than the amount of energy from the radiator reflected by the plurality of second metasurface units; or
the metasurface comprises a plurality of periodically arranged metasurface units and a plurality of lumped elements disposed between the metasurface units, and the inductance value and/or capacitance value of each lumped element in the plurality of lumped elements are configured such that the amount of energy from the radiator reflected by the first part of the metasurface is greater than the amount of energy from the radiator reflected by the second part of the metasurface.

8. A radiating element, including:
a feeder pillar;
a radiator positioned at the front end of the feeder pillar; and
a metasurface located in front of the radiator, wherein the metasurface includes a first part on the first side of the feeder pillar and a second part on the second side of the feeder pillar, which is opposite to the first side, and the metasurface is configured such that the amount of energy from the radiator reflected by the first part of the metasurface is greater than the amount of energy from the radiator reflected by the second part of the metasurface.

9. The radiating element according to claim 8, wherein the metasurface is offset by a distance relative to the feeder pillar toward a direction of the first side of the feeder pillar.

10. (canceled)

11. The radiating element according to claim 8, wherein the metasurface is rotated by an angle around a second direction transverse to the first direction, where the first direction points from the first side of the feeder pillar to the second side of the feeder pillar.

12. (canceled)

13. The radiating element according to claim 8, wherein the offset distance and/or the rotation angle of the metasurface are adjustable.

14. The radiating element according to claim 8, wherein the first part of the metasurface includes multiple first metasurface units arranged periodically, and the second part of the metasurface includes multiple second metasurface units arranged periodically, where the multiple first metasurface units are different from the multiple second metasurface units.

15. The radiating element according to claim 14, wherein the equivalent capacitance of the multiple first metasurface units is greater than the equivalent capacitance of the multiple second metasurface units, and/or the equivalent inductance of the multiple first metasurface units is greater than the equivalent inductance of the multiple second metasurface units.

16. The radiating element according to claim 14, wherein the periodic arrangement of the multiple first metasurface units and the periodic arrangement of the multiple second metasurface units are determined based on the intensity of the radiated energy in the direction in which grating lobes are formed in the antenna array where the radiating element is arranged.

17. The radiating element according to claim 8, wherein the metasurface includes a plurality of metasurface units arranged periodically and a plurality of lumped elements arranged between the metasurface units, where the inductance value and/or capacitance value of each lumped element in the plurality of lumped elements is adjustable.

18. The radiating element according to claim 17, wherein the capacitance value of the lumped elements in the first part of the metasurface is greater than the capacitance value of the lumped elements in the second part of the metasurface, and/or the inductance value of the lumped elements in the first part of the metasurface is greater than the inductance value of the lumped elements in the second part of the metasurface.

19. The radiating element according to claim 17, wherein the inductance value and/or capacitance value of each lumped element in the multiple lumped elements are determined based on the intensity of the radiated energy in the direction in which grating lobes are formed in the antenna array where the radiating element is arranged.

20. (canceled)

21. The radiating element according to claim 8, further including a director positioned in front of the radiator and behind the metasurface, wherein:
the radiator comprising a first part located on the first side of the feeder pillar and a second part located on the second side of the feeder pillar, wherein the size of the first part of the radiator is larger than the size of the second part; and/or
the director comprising a first part located on the first side of the feeder pillar and a second part located on the second side of the feeder pillar, wherein the size of the first part of the director is larger than the size of the second part.

22. A radiating element, including:
a feeder pillar;
a radiator positioned at the front end of the feeder pillar; and
a director positioned in front of the radiator, the director comprising a first part located on a first side of the feeder pillar and a second part located on a second side of the feeder pillar opposite the first side, wherein the size of the first part of the director is larger than the size of the second part.

23. The radiating element according to claim 22, wherein the first part and the second part of the director have the same shape.

24. (canceled)

25. The radiating element according to claim 22, wherein the radiator comprises a first part located on the first side of the feeder pillar and a second part located on the second side of the feeder pillar, wherein the size of the first part of the radiator is larger than the size of the second part.

26-32. (canceled)
